(19) United States
(12) Patent Application Publication
(10) Pub. No.: US 2005/0144050 A1
(43) Pub. Date: Jun. 30, 2005

(54) Apparatus, system and method for determining maximum payoff in multiparty negotiations

(76) Inventor: Douglas Morgan Trent, Raleigh, NC (US)

Correspondence Address: KUNZLER & ASSOCIATES, 8 EAST BROADWAY, SALT LAKE CITY, UT, 84111, US

(21) Appl. No.: 10/748,060

(22) Filed: Dec. 30, 2003

(51) Int. Cl. G06F 17/60

(52) U.S. Cl. 705/7

(57) ABSTRACT

An apparatus, system, and process for determining solutions with maximum payoff in a negotiation are provided. The invention includes calculating a sum of weighted option preference values for each option set of each issue across all parties. The sum of weighted option preferences is calculated from negotiation parameters determined by the negotiation parties. A maximum sum of weighted option preferences for each issue is calculated. The maximum of the sum of weighted option preferences for each issue forms an option set solution with the maximum negotiation payoff. The combined utility of the maximum negotiation payoff is equal to the sum of the maximum of the sum of the weighted option preferences. The convexity or degree of utility surplus in the negotiation is equal to the difference of the sum of the maximum of the sum of the weighted option preferences and one hundred percent divided by the number of parties minus one. The negotiation solution is determined with reduced computational resources.

### BACKGROUND OF THE INVENTION

1. Field of the Invention

The invention relates to modeling multiparty negotiations and more particularly, to determining the solution of maximum utility surplus in multiparty negotiations.

2. Description of the Related Art

Negotiations are common in many areas of business and society and are the underpinning of a free-market economy. At their core, negotiations are about improving market efficiency. Negotiations come about when two or more parties recognize they can make themselves better off by redistributing an inefficient allocation of goods and services. Negotiations typically involve a set of one or more issues, each issue having a selection of options to be mutually decided by the parties. As the number of parties, issues and options increase, a negotiation is more likely to become integrative, or win-win, such that each of the n parties can obtain better than a 1/n share of value or utility when the goods are redistributed, releasing latent utility surplus, and making the market more efficient.

Unfortunately, negotiations also increase rapidly in complexity as the number of parties, issues, and options increase. Human negotiators, left only to their intuition, are quickly overwhelmed by negotiation complexity in the search for a negotiation solution that unlocks the most utility surplus and delivers the maximum combined payoff to the parties. A negotiation solution is said to be efficient when no further utility gain to any party is possible without utility loss to another party. Research shows that humans rarely achieve efficient outcomes in negotiations. Due to the complexity of the negotiation, combined with human cognitive biases such as anchoring, availability, framing and a strong “fixed pie” or zero-sum mentality, human negotiators almost always leave utility surplus on the table.

Computer-based negotiation support systems have been created to help humans find efficient negotiation solutions. A typical computer model evaluates the option sets of each potential negotiation solution. The computer model calculates overall utility values of each option set for each party to the negotiation and identifies option sets that increase the utility of the negotiation solution to one or more of the parties. Additionally, the computer model may calculate the combined utility payoff to all parties of a negotiation solution.

Computer modeling allows for a significant increase in the complexity of a negotiation that can be evaluated. Yet even with computer modeling, a complex negotiation can generate option sets that are too numerous to be efficiently evaluated. The solution space of all possible option sets in a negotiation increases in complexity as the number of options raised to the power of the number of issues. The order of complexity is said to be exponential in issues. For example, an international dispute between two countries over 50 issues with five options per issue would generate a solution space of 55⁵⁰ or in excess of 8.8×10³⁴ potential option sets. Unfortunately, even a computer model has difficulty searching for the negotiation solutions that increase utility payoff for such complex negotiations in a timely manner.

Computer models based on heuristic algorithms have been created to reduce computational complexity. A heuristic algorithm typically starts at a given option set. The heuristic algorithm searches among “neighboring” option sets, sets with one or more different option selections, for an option set with a greater utility than the current issue option set. The process is continued until the heuristic algorithm locates an option set with greater utility than all of the neighboring option sets. Heuristic algorithms may diminish the computation complexity of calculating solutions. Unfortunately, many heuristic algorithms are not deterministic and may find only local maxima and not the negotiation solution that optimizes utility payoff by releasing maximum surplus utility.

Consequently, a need exists for a process, apparatus, and system that deterministically calculate the total amount of utility surplus realizable in a negotiation and identify an efficient negotiation solution of maximum utility surplus. What is more particularly needed is a process, apparatus, and system that drastically reduce the computational requirements for deterministically calculating a complex negotiation solution. Beneficially, such a process, apparatus, and system would deterministically calculate a solution of maximum utility payoff to complex negotiations with reasonable resources and within a practical period of time.

### BRIEF SUMMARY OF THE INVENTION

The present invention has been developed in response to the present state of the art, and in particular, in response to the problems and needs in the art that have not yet been fully solved by currently available negotiation modeling techniques. Accordingly, the present invention has been developed to provide a process, apparatus, and system for determining negotiation solutions with increased utility that overcome many or all of the above-discussed shortcomings in the art.

The apparatus for calculating a negotiation solution is provided with a logic unit containing a plurality of modules configured to functionally execute the necessary steps of determining a negotiation solution that increases the utility to the negotiation parties. These modules in the described embodiments include an input module, a storage module, a computation module, and an output module.

In one aspect of the present invention, the input module receives negotiation parameters from one or more parties. Parties input one or more issues, and identify one or more options for each issue. Each party may also identify an issue weight for each issue, indicating the importance of the issue to the party. The storage module stores all negotiation parameters and calculated negotiation results. The output module presents negotiation parameters, results, and choices to the parties.

In one aspect, the computation module creates one or more option sets. Each option set represents a possible negotiation solution. In one embodiment, the output module presents the option sets to each party. Each party may respond with the utility definition of the option set using the input module. The computation module may calculate an option preference of each option for each party from the utility definition. In an alternate embodiment, each party identifies an option preference for each option.

The computation module calculates a weighted option preference (“WOP”) for each option. The weighted option preference is the product of the party's issue weight and the party's option preference for the option. The computation module further calculates one or more sums of weighted option preferences (“SUWOP”) by summing the WOP of each negotiation party for each option across each issue. The computation module calculates one or more negotiation solutions from the SUWOPs, including the negotiation solution that maximizes the combined utility.

In one embodiment, the computation module calculates the maximum of the sum of weighted option preferences (“MASUWOP”) for each issue. The MASUWOP option set forms the issue option set with the maximum combined utility. The computation module may sum each MASUWOP to form a sum of the maximum of the sum of weighted option preferences (“SUMASUWOP”). The SUMASUWOP is the maximum combined utility payoff.

In one embodiment, the computation module calculates the convexity (“Convexity”) of the negotiation. The Convexity is a measure of the maximum utility surplus available in the solution space of the negotiation.

A system of the present invention is also presented for calculating a negotiation solution. The system may be embodied in a client/server computer system. In particular, the system, in one embodiment, includes one or more data processing device, a server, and a network.

The data processing device receives negotiation parameters from one or more negotiation parties and transmits the negotiation parameters over a network to a server. The server receives the negotiation parameters from the data processing device and calculates a WOP and SUWOP value for each option. The server calculates one or more negotiation solutions from the SUWOP values. In one embodiment, the negotiation solution is the option set with the maximum SUWOP value in each issue. In a certain embodiment, the server calculates the SUMASUWOP as the maximum combined utility.

In one embodiment, the server calculates one or more option sets and transmits the option sets over the network to the data processing device. Each party defines the utility of each party's option sets. The data processing device transmits the utility definitions to the server. The server calculates one or more option preferences corresponding to each option for each party from the utility definitions.

A process of the present invention is also presented for calculating a negotiation solution. The process in the disclosed embodiments substantially includes the steps necessary to carry out the functions presented above with respect to the operation of the described apparatus and system. In one embodiment, the process includes identifying one or more issues, determining an issue weight for each issue, recording one or more options for each issue, calculating each party's option preference for each option, calculating the WOP and SUWOP for each option, and calculating a negotiation solution using the SUWOP for each option to evaluate the various option sets as a potential negotiation solution.

In a further embodiment, the process includes identifying the options of a maximum SUWOP within each issue and calculating the MASUWOP. In one embodiment, the process includes calculating the negotiation solution with the maximum combined utility by calculating the SUMASUWOP, the options of the MASUWOP forming the option set of the negotiation solution.

The present invention determines the combined utilities of a multiparty negotiation solution with reduced computational effort. The present invention further identifies a negotiation solution of maximum combined utility with reduced computational effort. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram illustrating one embodiment of a negotiation solution device of the present invention;

FIG. 2 is a block diagram illustrating a negotiation solution system of the present invention;

FIG. 3 is a flow chart diagram illustrating one embodiment of a negotiation solution calculation process of the present invention;

FIG. 4 is a flow chart diagram illustrating one embodiment of a sum of weighted option preferences calculation process of the present invention; and

FIG. 5 is a flow chart diagram illustrating one embodiment of a negotiation solution identification process of the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

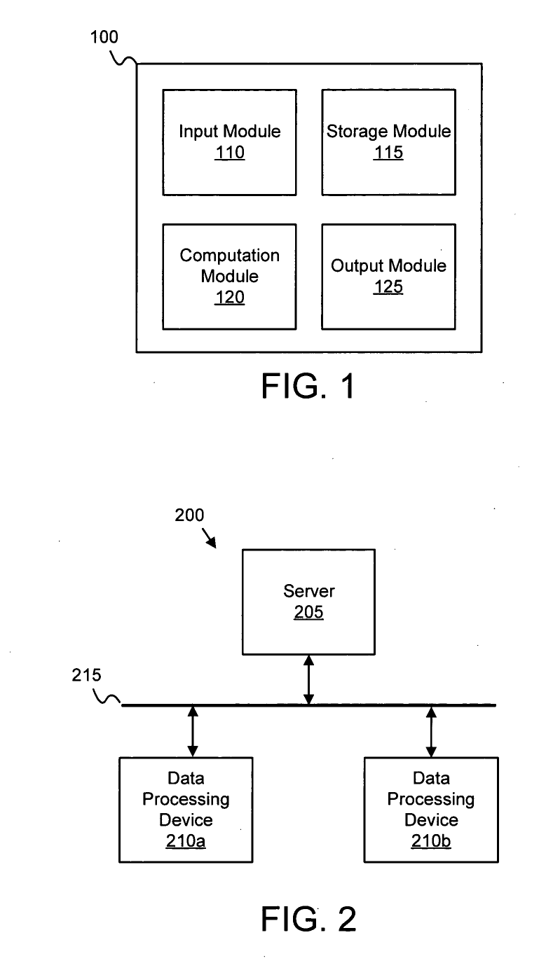

FIG. 1 depicts one embodiment of a negotiation solution device 100 of the present invention. The negotiation solution device 100 includes an input module 110, a storage module 115, a computation module 120, and an output module 125. The negotiation solution device 100 calculates the negotiation solution having the maximum combined utility to two or more parties.

The input module 110 receives negotiation parameters from two or more parties. In one embodiment, negotiation parameters include one or more issues, one or more options for each issue, one or more issue weights to indicate the relative importance of each issue to each party to the negotiation, and a option preference by each party for each option within each of the issues. The storage module 115 stores the negotiation parameters and the results of negotiation calculations.

In one example of a certain embodiment of the present invention, a negotiation includes two parties, parties A and B. The negotiation further consists of two issues, i₁ and i₂. Each party has an issue weight for each issue as shown in Table 1. The issue weight represents the relative importance of each issue to each party, with zero representing no importance and a larger number representing greater importance. The issue weights may be expressed in any unit of measure that is common among the parties.

Negotiation convexity (“Convexity”) is a measure of the maximum utility surplus available in the potential solution space of the negotiation. In addition, the Convexity indicates how integrative and win-win the solution space is. To calculate the negotiation Convexity (“Convexity”), the issue weights may be normalized by adjusting the issue weights across all issues to sum to one hundred percent (100%) for each party.

TABLE 1

| Issue | Party A Issue Weight | Party B Issue Weight |
|---|---|---|
| issue i₁ | 30% | 60% |
| issue i₂ | 70% | 40% |

Each issue in the example also has two options, x₁ and x₂. Each party has a option preference for each option within each issue as shown in Tables 2 and 3. The parties will typically rate the option preference for an option in terms of the relative utility that each option delivers compared to the other options of the issue. The option preference may be expressed in any common unit of measure. To enable the calculation of the Convexity, the option preferences may be normalized to a maximum of one hundred percent (100%) signifying complete allocation of the issue to that party.

TABLE 2

| Party A Option Preferences | issue i₁ | issue i₂ |
|---|---|---|
| option x₁ | 0.3 | 0.2 |
| option x₂ | 1.0 | 1.0 |

TABLE 3

| Party B Option Preferences | issue i₁ | issuei₂ |
|---|---|---|
| option x₁ | 1.0 | 1.0 |
| option x₂ | 0.1 | 0.4 |

The computation module 120 calculates the weighted option preferences (“WOP”) for each option of the negotiation. Equation 1 shows the calculation of the WOP for one or more options of issue i, Xᵢ. The calculation yields WOPₚ(Xᵢ) the WOP of each option for each party p. The option preference of all parties for each option OPₚ(Xᵢ) are multiplied by the issue weight Wₚᵢ of each party p for each issue i.
WOPₚ(Xᵢ)=Wₚᵢ×OPₚ(Xᵢ) Equation 1

In Equation 1, Xᵢ is the array of n options {x₁ x₂, . . . xₙ} for each issue i of I issues, where I is greater than or equal to one (1). OPₚ(Xᵢ) returns the option preferences of party p for the options of issue i. Wₚᵢ represents the relative importance of issue i to party p of P parties, where P is greater than or equal to two (2). To calculate Convexity, the option preferences are normalized to one hundred percent (100%) and the sum of the issue weights across all issues will equal one (1) for each party, as shown in Equation 2:

$${\sum }_{i = 1}^{I} {W}_{pi} = 1 \qquad Equation 2$$

Tables 4 and 5 show the WOP of each party for each option of each issue in the example negotiation.

TABLE 4

| Party A WOP | issue i₁ | issue i₂ |
|---|---|---|
| option x₁ | 30% × 0.3 = 0.09 | 70% × 0.2 = 0.14 |
| option x₂ | 30% × 1.0 = 0.3 | 70% × 1.0 = 0.7 |

TABLE 5

| Party B WOP | i₁ | i₂ |
|---|---|---|
| option x₁ | 60% × 1.0 = 0.6 | 40% × 1.0 = 0.4 |
| option x₂ | 60% × 0.1 = 0.06 | 40% × 0.4 = 0.16 |

The computation module 120 calculates the sum of the weighted option preferences (“SUWOP”) for each option of the negotiation. Equation 3 shows the calculation of the SUWOP for one or more options of issue i, Xᵢ. The calculation yields SUWOP (Xᵢ), the sum of the weighted option preferences of each option for each party. The WOP of each party's options are summed across all the parties.

$$SUWOP ( {X}_{i} ) = {\sum }_{p = 1}^{P} {WOP}_{p} ( {X}_{i} ) = {\sum }_{p = 1}^{P} {W}_{pi} \times {OP}_{p} ( {X}_{i} ) \qquad Equation 3$$

Table 6 shows the SUWOP for each option of the example negotiation.

TABLE 6

| SUWOP | issue i₁ | issue i₂ |
|---|---|---|
| option x₁ | 0.09 + 0.6 = 0.69 | 0.14 + 0.4 = 0.54 |
| option x₂ | 0.3 + 0.06 = 0.36 | 0.7 + 0.16 = 0.86 |

In one embodiment, the computation module 120 calculates a negotiation solution using the SUWOP of each option. The computation module 120 may calculate the negotiation payoff for one or more option sets as the sum of the SUWOPs for each option in the option set. By comparing the negotiation payoffs of the option sets, the computation module 120 may select option sets with greater combined utility as the negotiation solution. The computation module 120 communicates the negotiation solution and the combined utility or negotiation payoff to each party through the output module 125.

In a further embodiment, the computation module 120 calculates the maximum of the sum of the weighted option preferences (“MASUWOP”) for each issue of the negotiation. Equation 4 shows the calculation of the MASUWOP for issue i. The maximum SUWOP of each issue i is selected.

$$MASUWOP = Maximum ( SUWOP ( {X}_{i} ) ) = Maximum ( {\sum }_{p = 1}^{P} {W}_{pi} \times {OP}_{p} ( {X}_{i} ) ) \qquad Equation 4$$

For the negotiation example, the option with the maximum SUWOP is selected as shown in table 7:

TABLE 7

| | issue i₁ | issue i₂ |
|---|---|---|
| option | x₁ | x₂ |
| MASUWOPᵢ | 0.69 | 0.86 |

In a further embodiment, the computation module 120 calculates the sum of the maximum of the sum of the weighted option preferences (“SUMASUWOP”) for the negotiation. Equation 5 shows the calculation of the SUMASUWOP for the negotiation. The MASUWOPᵢ is summed across all issues i.

$$SUMASUWOP = {\sum }_{i = 1}^{I} {MASUWOP}_{i} = {\sum }_{i = 1}^{I} Maxumum ( {\sum }_{p = 1}^{P} {W}_{pi} \times {OP}_{p} ( {X}_{i} ) ) \qquad Equation 5$$

In the example negotiation, the SUMASUWOP is 0.69+0.86=1.55. The solution option set of the SUMASUWOP is option x₁ for issue i₁ and option x₂ for issue i₂.

Calculation of the SUMASUWOP is deterministic and has an order of complexity that is linear in options and issues. In the example in the background of the invention of the two countries negotiating 50 issues of five options each, the complexity of the negotiation solved by the negotiation solution device 100 is on the order of 250, a substantial improvement over 8.8×10³⁴ The order of complexity for the SUMASUWOP calculation is largely independent of the number of parties.

For all negotiations, the SUMASUWOP indicates the negotiation solution of maximum combined utility to the parties. The SUMASUWOP negotiation solution is not guaranteed to be egalitarian. The combined utility may not be equally shared among the parties and may differ dramatically. In this event, balancing payments may be used as needed to redistribute the utility surplus more evenly.

The SUMASUWOP solution is not guaranteed to be unique. There may be other solutions of equal combined utility. These other solutions will be easily identified during the MASUWOP stage when two or more options within an issue have equal SUWOP values. Although the SUMASUWOP solution is possibly not unique, no other solution will have greater combined utility to the parties. Therefore, the SUMASUWOP solution is efficient and delivers the maximum combined payoff to the parties. The SUMASUWOP solution also captures the maximum utility surplus that can be realized in the negotiation.

In a further embodiment, the computation module 120 calculates the Convexity of the negotiation. As discussed previously, the measure of utility surplus can be taken only when each party's issue weights across all issues sum to one hundred percent (100%), and when all option preferences are normalized to a maximum of one hundred percent (100%).

The Convexity is calibrated to range from zero percent (0%) for a purely distributive, zero-sum solution space, to one hundred percent (100%) for a purely integrative, win-win solution space. Equation 6 shows the calculation for the Convexity of a negotiation. The SUMASUWOP value, minus one hundred percent (100%), is divided by one less than the number of parties P to the negotiation. The number of parties P is always greater than or equal to 2.

$$Convexity = \frac{SUMASUWOP - 100 \%}{P - 1} \qquad Equation 6$$

In the example negotiation, the Convexity is (1.55-100%)/(2-1) or fifty-five percent (55%). The solution space for the example negotiation is roughly midway between purely distributive and purely integrative.

In one embodiment, the computation module 120 calculates one or more option sets and communicates the options sets to each party through the output module 125. Each party may respond with a utility definition for each option set through the input module 110. The computation module 120 may receive one or more utility definitions from the input module 110 and calculate the option preference of each option for each party. In a certain embodiment, the option preferences are calculated using hybrid conjoint analysis. The option preferences may also be calculated using multi-attribute utility analysis.

The negotiation solution device 100 determines a negotiation solution with reduced computational resources by calculating the SUWOP for each option of a negotiation. The negotiation solution device 100 further determines the negotiation solution with the maximum combined utility by calculating the SUMASUWOP for the negotiation.

FIG. 2 is a block diagram illustrating one embodiment of a negotiation solution system 200 of the present invention. The negotiation solution system 200 includes a server 205, one or more data processing devices 210, and a network 215. The negotiation solution system 200 calculates a negotiation solution for one or more parties connected by the network 215.

The data processing device 210 receives negotiation parameters from one or more negotiation parties and transmits the negotiation parameters to the server 205 over the network 215. The server 205 calculates the SUWOP for each option of each issue. In addition, the server 205 calculates one or more negotiation solutions from the SUWOP values. The server 205 transmits the negotiation solutions over the network 215 to the data processing devices 210.

In one embodiment, the server 205 calculates the MASUWOP for each issue. The MASUWOP option set forms the option set of the negotiation solution with the maximum combined utility. The server 205 may also calculate maximum combined utility value SUMASUWOP.

In one embodiment, the sever 205 calculates one or more options sets and communicates the options sets to each negotiation party through the network 215 to the data processing device 210. Each negotiation party may respond with a utility definition for each option set through the data processing devices 210. In a certain embodiment, the server 205 receives the utility definitions from the data processing devices 210 and calculates the option preference of each option for each party. The negotiation solution system 200 allows one or more parties in multiple locations to create one or more negotiation solutions over a network 215 while reducing the computational resources required for the negotiation solution.

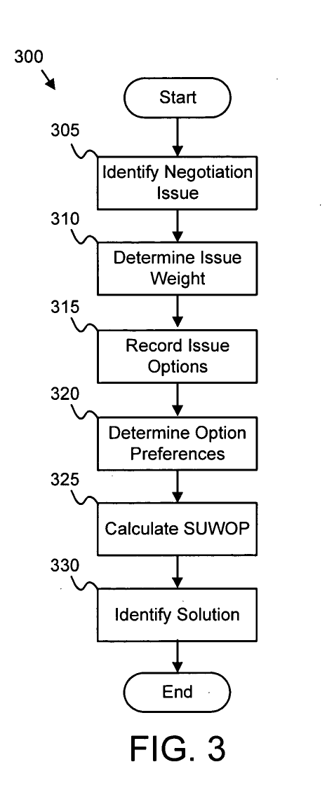

FIG. 3 is a flow chart diagram illustrating one embodiment of a negotiation solution calculation process 300 of the present invention. The negotiation solution calculation process 300 determines one or more negotiation solutions from the negotiation parameters. Although for purposes of clarity the negotiation solution calculation process 300 is depicted in a certain sequential order, execution may be conducted in parallel and not necessarily in the depicted order.

The negotiation solution calculation process 300 identifies 305 one or more issues for the negotiation. One or more parties may identify the issues. In an alternate embodiment, a moderator may identify the issues. Each party also determines 310 an issue weight for each issue in the negotiation. In one embodiment, the sum of the issue weights for each party is one.

The negotiation solution calculation process 300 records 315 one or more options for each issue. The options may be recorded 315 from party inputs. The options may also from the moderator. The negotiation solution calculation process 300 further determines 320 the option preferences of each party for each option. In one embodiment, negotiations solution calculation process 300 determines 320 the option preferences from inputs from the parties. In an alternate embodiment, the negotiation solution calculation process 300 determines 320 the option preferences from the utility definitions of the parties in response to selected option sets. In a certain embodiment, the option preferences are calculated using hybrid conjoint analysis. The option preferences may also be calculated using multi-attribute utility analysis.

The negotiation solution calculation process 300 calculates 325 the SUWOP of each issue option as shown in Equation 3. In addition, the negotiation solution calculation process 300 identifies 330 a negotiation solution for the negotiation from the SUWOP values. In one embodiment, the negotiation solution is the option set of the MASUWOP options as calculated in Equation 4. In an alternate embodiment, the negotiation solution is an option set where each negotiation party achieves a minimum negotiation utility. The negotiation solution calculation process 300 calculates a negotiation solution with reduced computational requirements. In addition, the negotiation solution calculation process 300 may also calculates the negotiation solution with the maximum combined utility.

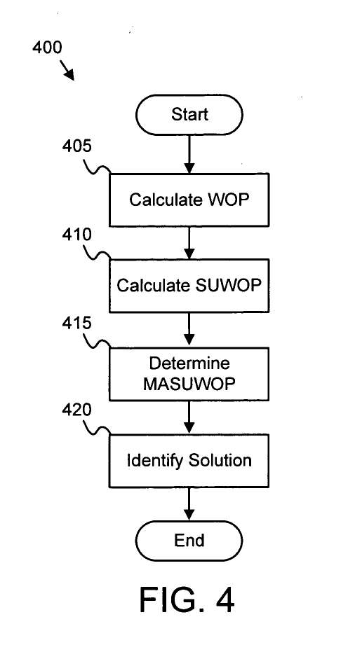

FIG. 4 is a flow chart diagram illustrating one embodiment of a SUWOP calculation process 400 of the present invention. The SUWOP calculation process 400 calculates the SUWOP values used to determine a negotiation solution. Although for purposes of clarity the SUWOP calculation process 400 is depicted in a certain sequential order, execution may be conducted in parallel and not necessarily in the depicted order.

The SUWOP calculation process 400 calculates 405 the WOP of each option for each party as shown in Equation 1 and further calculates 410 the sum of the weighted option preferences to form the SUWOP for each option as shown in Equation 3. In one embodiment, the SUWOP calculation process 400 determines 415 the MASUWOP values for each issue option. The SUWOP calculation process 400 may identify 420 the negation solution as the option set of the MASUWOP options. The SUWOP calculation process 400 calculates the SUWOP values for creating one or more negotiation solutions with reduced computational resources.

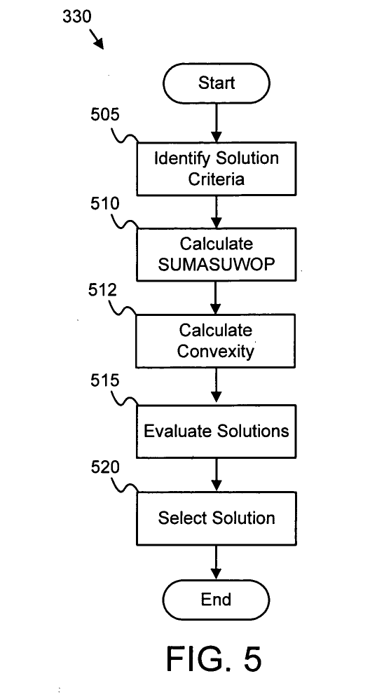

FIG. 5 is a flow chart diagram illustrating one embodiment of a negotiation solution identification process 330 of the present invention. The negotiation solution identification process 330 determines a negotiation solution for the negotiation solution identification process 330 of FIG. 3 guided by the MASUWOP option set. Although for purposes of clarity the negotiation solution identification process 330 is depicted in a certain sequential order, execution may be conducted in parallel and not necessarily in the depicted order.

The negotiation solution identification process 330 identifies 505 one or more solution criteria for the negotiation solution. In one embodiment, the solution criteria may be selecting the negotiation solution with the maximum combined utility. In an alternate embodiment, the solution criteria may be achieving a minimum negotiation utility for each negotiation party.

The negotiation solution identification process 330 calculates 510 the SUMASUWOP for the negotiation and the corresponding negotiation solution. The SUMASUWOP negotiation solution represents the maximum combined utility. In one embodiment, the solution identification process 300 calculates 512 the Convexity of the negotiation. The negotiation solution identification process 300 evaluates 515 the SUMASUWOP negotiation solution and negotiation solutions similar to SUMASUWOP for compliance with the solution criteria.

The negotiation solution identification process 330 selects 520 a negotiation solution conforming to the selection criteria. The negotiation payoff may be improved by evaluating conforming negotiation criteria near the SUMASUWOP negotiation solution. The negotiation solution identification process 330 allows the selection of a negotiation solution that may have a combined utility that is less than the maximum combined utility, but that satisfies other selection criteria for the negotiation.

The present invention determines the negotiation payoffs of negotiation solutions with reduced computational effort. The present invention further identifies a negotiation solution with the desired negotiation utilities with reduced computational effort. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A data processing apparatus for calculating a negotiation solution, the apparatus comprising:
an input module configured to receive an issue, a plurality of issue weights of a plurality of parties for the issue, and a plurality of options of the issue, the input module further configured to receive a plurality of option preferences of each option for each party;
a storage module configured to store the issue, the issue weights, the options, and the option preferences;
a computation module configured to calculate a plurality of weighted option preferences of each option for each party, wherein each weighted option preference is the issue weight of the party multiplied by the option preference of the party, the computation module further configured to calculate a sum of weighted option preferences for the issue by summing the weighted option preferences for each option of the issue, the computation module further configured to calculate a negotiation solution from the sum of weighted option preferences; and
an output module configured to display the issue, the options, an option set, and the negotiation solution.

2. The data processing apparatus of claim 1, wherein the computation module identifies the maximum of the sum of weighted option preferences for the issue.

3. The data processing apparatus of claim 2, wherein the computation module identifies the negotiation solution as the option set of the maximum of the sum of weighted option preferences, the computation module further calculating the sum the maximum of the sum of weighted option preferences of the issue to form a maximum combined utility.

4. The data processing apparatus of claim 3, the computation module configured to calculate the convexity of the negotiation, the convexity equal to the difference of the sum of the maximum of the sum of the weighted option preferences and one hundred percent divided by the number of parties to the negotiation minus one.

5. The data processing apparatus of claim 1, the computation module configured to create at least one option set responsive to inputs of the negotiation issue, the issue weight, and the option, the output module configured to communicate the at least one option set to each party, the input module receiving a utility definition from each party in response to the option set, the computation module configured to calculate the option preference of each party in response to the utility definition.

6. The data processing apparatus of claim 1, wherein the computation module calculates a negotiation solution by selecting the option set with a minimum sum of weighted option preferences for the issue.

7. The data processing apparatus of claim 1, wherein the option preference is calculated according to multi-attribute utility analysis.

8. A system for calculating a negotiation solution, the system comprising:
a data processing device configured to receive and display an issue, a plurality of options for the issue, and a plurality of parties, the data processing device further configured to receive and display an issue weight of each party for the issue, and an option preference of each option for each party;
a server configured to receive the issue, the options, the parties, the issue weights, and the option preferences from the data processing device, the server further configured to calculate a plurality of sum of weighted option preferences as the sum of the products of the issue weight of each option for each party and the option preferences of each option for each party and to calculate a negotiation solution from the sum of weighted option preferences; and
a network configured to communicate between the data processing device and the server.

9. The system of claim 8, wherein the server is further configured to calculate the maximum of the sum of weighted option preferences for the issue.

10. The system of claim 9, wherein the server is further configured to identify the negotiation solution as the option set of the maximum of the sum of weighted option preferences, the server further summing the maximum of the sum of weighted option preferences for the issue to form a maximum combined utility.

11. The system of claim 10, wherein the server is further configured to calculate the convexity of the negotiation, the convexity equal to the difference of the sum of the maximum of the sum of weighted option preferences and one hundred percent divided by the number of parties minus one.

12. The system of claim 8, wherein the server is further configured to calculate a combined utility for an option set.

13. The system of claim 8, wherein the server is further configured to create at least one option set responsive to the issue, the issue weights, and the options, the server also configured to communicate the at least one option set to the data processing device, the data processing device communicating a utility definition to the server responsive to the at least one option set, the server further configured to calculate the option preferences responsive to the utility definition.

14. A process for calculating a negotiation solution, the process comprising:
identifying an issue;
determining a plurality of issue weights of the issue for a plurality of parties;
recording a plurality of options for the issue;
calculating a plurality of option preferences of each option for each party;
calculating a plurality of sum of weighted option preferences for the issue wherein the sum of weighted option preferences is the sum of the issue weight of each option for each party multiplied by the option preference of each option for each party; and
calculating a negotiation solution from the sum of weighted option preferences, the negotiation solution comprising an option set.

15. A process for calculating a sum of weighted option preferences for a negotiating issue, the process comprising:
multiplying a plurality of issue weights of a plurality of options for a plurality of parties by a plurality of option preferences of the plurality of options for the plurality of parties to form a plurality of weighted option preferences; and
summing the plurality of weighted option preferences of each option for each party of the issue to form a sum of weighted option preferences.

16. The process of claim 15, further comprising calculating the maximum of the sum of weighted option preferences for the issue.

17. The process of claim 16, further comprising identifying a negotiation solution of the option set of the maximum of the sum of weighted option preferences for the issue and summing the maximum sum of weighted option preferences to form a maximum combined utility.

18. The process of claim 17, further comprising calculating the convexity of the negotiation, the convexity equal to the difference of the sum of the maximum of the sum of the weighted option preferences and one hundred percent divided by the number of parties minus one.

19. A computer readable storage medium comprising computer readable code configured to carry out a process for calculating a negotiation solution, the computer readable code configured to:
identify an issue;
determine a plurality of issue weights of the issue for a plurality of parties;
recording a plurality of options for the issue;
calculating a plurality of option preferences of each option for each party;
calculating a plurality of sum of weighted option preferences for the issue wherein the sum of weighted option preferences is the sum of the issue weight of each option for each party multiplied by the option preference of each option for each party; and
calculating a negotiation solution from the sum of weighted option preferences, the negotiation solution comprising an option set.

20. The computer readable storage medium of claim 19, further comprising computer readable code configured the sum of the maximum of the sum of weighted option preferences for the issue, wherein the sum of the maximum of the sum of weighted option preferences is the maximum combined utility.

21. The computer readable storage medium of claim 20, further comprising computer readable code wherein the negotiation solution is the option set of the maximum of the sum of weighted option preferences for each issue.

22. The computer readable storage medium of claim 19, further comprising computer readable code wherein the sum of the issue weights for a party is equal to one.

23. The computer readable storage medium of claim 19, further comprising computer readable code wherein the option preference is calculated according to multi-attribute utility analysis.

24. The computer readable storage medium of claim 19, further comprising computer readable code wherein the option preference is calculated according to hybrid conjoint analysis.

25. A computer readable storage medium comprising computer readable code configured to calculate a sum of weighted option preferences for an issue, the process configured to:
multiply a plurality of issue weights of a plurality of options for a plurality of parties by a plurality of option preferences of the plurality of options for the plurality of parties to form a plurality of weighted option preferences; and
sum the plurality of weighted option preferences of each option for each party of the issue to form a sum of weighted option preferences.

26. The computer readable storage medium of claim 25, further comprising computer readable code configured to calculate the maximum of the sum of weighted option preferences for the issue.

27. The computer readable storage medium of claim 26, further comprising computer readable code configured to identify a negotiation solution as the option set of maximum of the sum of weighted option preferences and to sum the maximum of the sum of weighted option preferences to form a maximum combined utility.

28. The computer readable storage medium of claim 27, further comprising computer readable code configured to calculate the convexity of the negotiation, the convexity equal to the difference of the sum of the maximum of the sum of weighted option preferences and one hundred percent divided by the number of parties minus one.

29. The computer readable storage medium of claim 25, further comprising computer readable code configured to normalize the sum of the issue weights for the party to one.

30. An apparatus for calculating a negotiation solution, the apparatus comprising:
means for identifying an issue;
means for determining a plurality of issue weights of the issue for a plurality of parties;
means for recording a plurality of options for the issue;
means for calculating a plurality of option preferences of each option for each party;
means for calculating a plurality of sum of weighted option preferences for the issue wherein the sum of weighted option preferences is the sum of the issue weight of each option for each party multiplied by the option preference of each option for each party; and
means for calculating a negotiation solution from the sum of weighted option preferences, the negotiation solution comprising an option set.
